(19) United States
(12) Patent Application Publication
(10) Pub. No.: US 2008/0288411 A1
(43) Pub. Date: Nov. 20, 2008

(54) METHODS, MEDIA, AND SYSTEMS FOR TRACKING AND ENCRYPTING CONTENT USAGE

(76) Inventor: Devon Copley, Brooklyn, NY (US)

Correspondence Address: WILMERHALE/BOSTON, 60 STATE STREET, BOSTON, MA, 02109, US

(21) Appl. No.: 11/750,122

(22) Filed: May 17, 2007

(51) Int. Cl. G06Q 10/00; H04L 9/00

(52) U.S. Cl. 705/52; 705/51; 705/59

(57) ABSTRACT

A content management system distributes items of media content to groups of users. The media is fingerprinted and tracked for reporting purposes. The system uses an algorithm to compensate for multiple content owners. The system can also be configured to provide content while still providing anonymity for actual use.

### TECHNOLOGY AREA

The disclosed subject matter relates to methods, media, and systems for content usage tracking and royalty determination.

### BACKGROUND

The Internet has created a significant demand for users to be able to download and/or stream digital content. This content can include, for example, text, audio clips, still images, motion video, and combinations.

A significant amount of content is available for free over the Internet. However, there are also many services that provide content for fees or royalties. Such compensation can be paid per use, per hit, per download (such as downloading an article from a journal), or on a subscription basis, such as through a monthly or annual fee. Combinations of these approaches are possible, such as providing a monthly fee for a certain number of hits, and then a per hit fee thereafter.

A party can aggregate content and then make payments based on individual uses. For example, a website could offer a catalogue of songs for download, and each time a song is downloaded and paid for, the website pays the appropriate royalties to the artists for the song. Alternatively, a content aggregator could purchase content from a variety of sources on a fixed fee basis or on a percentage basis, and make that content available to users for a fee. For example, some financial services websites aggregate a variety of different services that individual or professional investors can use.

Still another model is used for public performance copyright rights. The right to publicly perform copyrighted material is a right that is severable from other copyright rights, such as the right to copy or the right to make derivative works. Many artists license or assign public performance rights to agencies, such as BMI and ASCAP, that aggregate these rights. BMI and ASCAP then license entities for their catalogs, including site license based on formulas, such as square footage of a restaurant or a number of seats in a stadium. BMI and ASCAP then allocate payments among the artists based on some criteria, such as copies sold and/or number of times the song is played publicly over the radio.

A system that aggregates content from a variety of different owners and uses different types of content can create challenges in tracking usage and fairly compensating content owners.

### SUMMARY

The systems and methods described here are designed for a content distribution system, and typically with a system that aggregates different types of content from different owners and licenses that content to users or a group of users. The license to users can be on an individual basis, but can also be on a group basis, such as to a business, a business campus, a college campus, or a municipal community. The embodiments described here have a number of features and aspects, including an overall system architecture, methods and systems for fingerprinting and tracking usage, methods and systems for distributing royalty payments, and methods for providing some degree of anonymity for users while still recording usage statistics.

Using these embodiments, digital content including, for example, audio, video, television programs, photos, games, documents, and/or voice recordings can be distributed to users in an efficient manner. In addition, these embodiments can also be used to track, count, and/or report content usage, based on which appropriate compensation to owners of the content may be calculated and distributed. Users can be provided with unlimited exchange (e.g., downloading, streaming, and/or copying) of a vast library of licensed digital content with no technical protections or Digital Rights Management (DRM) constraints, while the users may only need to pay, for example, a flat monthly subscription fee.

Other features and advantages will become apparent from the following detailed description, drawings, and claims.

### BRIEF DESCRIPTION OF THE DRAWINGS

The detailed description, including the description of various embodiments of the invention, will be best understood when read in reference to the accompanying figures wherein:

FIG. 1 is diagram providing an overview of a system according to various embodiments of the present inventions;

FIG. 2 is a block diagram illustrating a system according to various embodiments of the present inventions;

FIG. 3 is a flow chart illustrating operations performed by a user tracking system according to various embodiments of the present inventions;

FIG. 4 is a diagram illustrating a method for protecting user privacy according to various embodiments of the present inventions;

FIG. 5 is a diagram illustrating a method for determining royalty payments according to various embodiments of the present inventions; and

FIG. 6 is a block diagram illustrating another system according to various embodiments of the present inventions.

### DETAILED DESCRIPTION

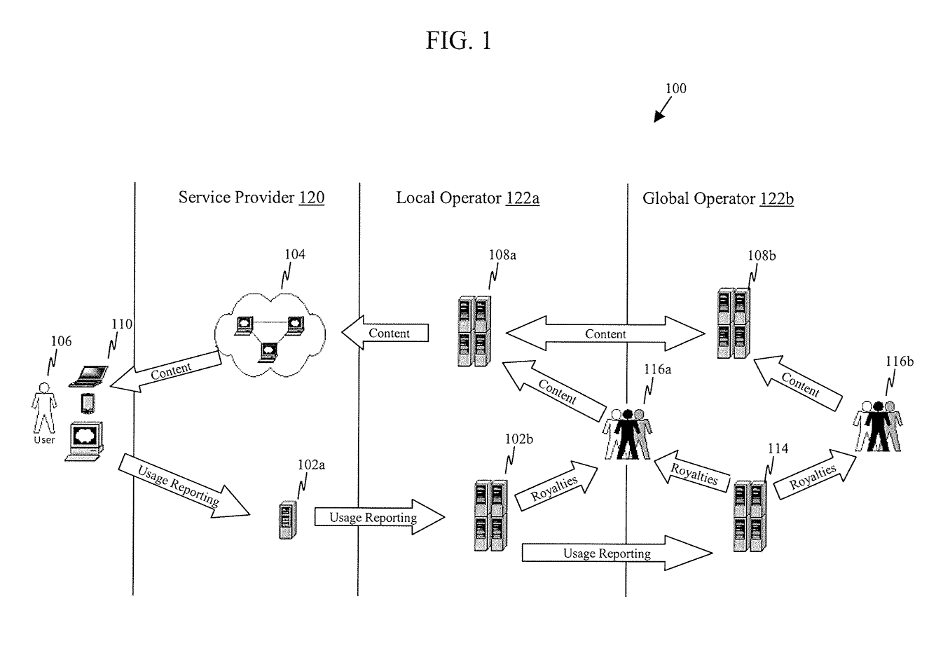

FIG. 1 is a high-level diagram of a system 100 according to various embodiments of the present inventions, illustrating the flow of content, usage information, and royalties among various components of the system. System 100 can include one or more content servers, such as a local content server 108a located at local operator 122a and/or a global content server 108b located at global operator 122b, for storing various content provided by content owners 116a, 116b. Local content server 108a can, for example, receive and store content from local content owners (e.g., local publishers) 116a, and global content server 108b can receive and store content from global content owners (e.g., global publishers) 116b. Further, local content server 108a and global content server 108b may further exchange content with one another.

User 106 can use any suitable network device 110 (e.g., networked computer, personal digital assistant, cell phone, etc.) to retrieve desired content that originated from content servers 108a, 108b using distribution network 104. Distribution network 104 may be a peer-to-peer (P2P) network with nodes located at service provider 120. Service provider 120 can be an Internet Service Provider (ISP). In this case, content server 108a may act as an initial seeder that delivers initial copies of content files to distribution network 104.

In some embodiments, distribution network 104 may be a P2P network that utilizes one or more levels of hierarchical super-peer servers (not shown). In such a P2P network, a super-peer server can act as a centralized server to a subset of client nodes in the P2P network, maintain an index of data available on the subset of client nodes, and answer queries sent from a client node or another super-peer server. In some embodiments, super-peer servers can be used to provide a desired quality of service (QoS) to users. For example, if client nodes in the P2P network do not have sufficient bandwidth, processing power, and/or other resources available at a given time to serve one or more users, a super-peer server that has more bandwidth, processing power, and/or other resources may be queried by a user and may send one or more blocks of a requested file to the user to satisfy the users' requests. A super-peer server may be a computer located at service provider 120 with dedicated resources. Content may be downloaded or streamed to user 106.

The system is shown in FIG. 1 as used by an individual user. While the system could work with an individual user, the content system can be set up for distribution to people within a group, such as a building, a work facility, a college campus, a municipal community, or some other group of individuals. When this is the case, the providers of the content management system may need to contract only with the group leader, such as business management, university management, or municipal officials, for payment for the content. Individual users in such a case would typically be required to agree to usage contracts in which the individual users would then agree to not use the data in unauthorized ways.

Usage of content by user 106 can be tracked, counted, and/or reported to one or more usage tracking servers. For example, content usage may be first reported to usage tracking server 102a located at service provider 120, and further reported by server 102a to usage tracking server 102b located at local operator 122a. Server 102b may further report content usage to global accounting server 114. Usage tracking servers 102a, 102b and/or global accounting server 114 can administer rights and ownership of various content to be distributed to users (e.g., user 106). Based on reported content usage, usage tracking server 102b and/or global accounting server 114 can calculate and distribute royalties to content owners 116a and/or 116b respectively.

As shown in FIG. 1, local operator 122a, which can include local content server 108a and local usage tracking server 102b, may act as an intermediary between service provider 120 and global operator 122b for content distribution and usage reporting. Local operator 122a can communicate with one or more service providers (e.g., service provider 120) and can provide centralized administration for a particular territory (e.g., a state or a country). Local operator 122a and/or local service provider 120 can provide a user interface that is customized for the particular territory and/or the service provider so that user 106 can easily search and retrieve desired content. For example, the user interface may be customized with language(s) used in the particular territory. As another example, a university service provider may provide the university community a unique user interface that provides users easy access to educational materials.

Although FIG. 1 shows local operator 122a acting as an intermediary between service provider 120 and global operator 122b for content distribution and usage reporting, this need not be the case. In alternative embodiments, contents may be delivered directly from, e.g., global content server 108b to distribution network 104, and content usage may be sent to global accounting server 114 directly from device 110 and/or usage tracking server 102a.

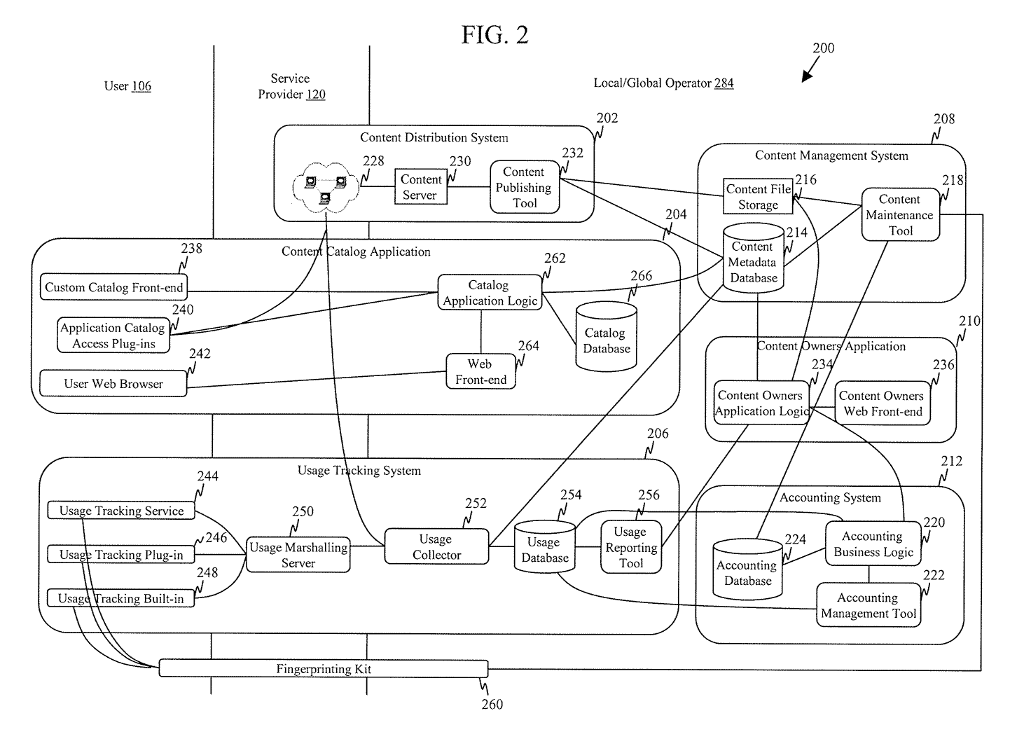

FIG. 2 is a block diagram of system 200 illustrating various embodiments. System 200 includes various subsystems, for example, fingerprinting kit 260, content distribution system 202, usage tracking system 206, content management system 208, content catalog application 204, content owners application 210, and/or accounting system 212. Each of these subsystems can be operated by one or more of user 106, service provider 120, and/or local (and/or global) operator 284, i.e., each of these subsystems can be located in different locations and/or can have functions that are distributed over multiple locations. In addition, different subsystems of system 200 that reside at a particular location may be installed and/or combined in a single computer or device. For example, usage tracking service 244 of usage tracking system 206 and user web browser 242 of content catalog application may be installed in a single user device.

Fingerprinting kit 260 is provided for fingerprinting content to provide a shortened form that can be used to represent and identify the content. It can be used by various subsystems of system 200, for example, usage tracking system 206, and content management system 208 to perform fingerprinting tasks. Fingerprinting kit 260 can be a library of fingerprinting functions designed to perform file-based or content-based fingerprints on all types of media files, including, but not limited to, audio files, video files, documents, executables, and/or images. In some embodiments, fingerprinting kit 260 can first analyze the file presented for fingerprinting and determine the type of the file, and then apply appropriate fingerprinting algorithm(s) according to the file type. Fingerprinting kit 260 may, for example, include libraries for file-hash fingerprinting for use on documents and executables, textual fingerprinting for use on text files, audio fingerprinting for use on audio files (e.g., MPEG-1 Audio Layer-3 (MP3) files, Waveform Audio Format (WAV) files, and the like), video fingerprinting for use on video files, and/or image fingerprinting for use on still images. Fingerprinting kit 260 may use any suitable fingerprinting algorithm. Fingerprinting kit 260 can also generate one or more fingerprints representing one or more segments of a content file. For example, when a particular segment of a media file is played, fingerprinting kit 260 may be used to generate fingerprint(s) for that particular segment.

Content management system 208, which may be located at local (and/or global) operator 284, can be used to import, store, and maintain digital content. Content management system 208 can include content file storage 216 for storing the large volume of content files maintained by system 200. Storage 216 can be used to retain authoritative copies of all content managed by local (or global) operator 284.

Content management system 208 can also include a content metadata database 214 for storing metadata associated with the managed content. Information stored in content metadata database 214 can include content details (e.g., title and author), content identification codes (e.g., International Standard Recording Code (ISRC), or International Standard Book Number (ISBN), International Standard Musical Work Code (ISWC)), and/or cross-references to content file storage 216 (i.e., locations where content items are stored in content file storage 216). For a single content item, content metadata database 214 may include multiple cross-references to content file storage 216 because the content item may be stored as multiple content files, for example, using different compression formats. Furthermore, content metadata database 214 can include cross-references to one or more distribution networks, and/or links where the content may be retrieved (e.g., BitTorrent links in P2P networks), which may differ for different service providers. In addition, content metadata database 214 can include a fingerprint database (not shown) that stores one or more fingerprints for each content item. A single content item may be fingerprinted using one or more algorithms on one or more content files.

This description sometimes refers to “content” or to a “content item” or a “content file.” A content item or content file can be any identifiable piece of content and can include an article, audio clip, video clip, executable, or text file. In addition, a content item can also be said to have multiple content items within it. For example, an article could have text and images, in which case the text and each of the images could be considered as and treated as, separate content items. In the case of a video clip, the content item could be considered the video clip with a combination of moving images and an audio file, or the audio and video can each be considered content items within one larger content item. Generally, a content item would not refer to multiple unrelated pieces of media just because they were stored in the same memory.

Content metadata database 214 can also include information relating to content permissions, such as territories where a license is obtained for a content item, permission to extract or combine music, lyrics, dialog, and images for creating derivative works (such as translations or music soundtracks), sampling of work fragments for recombination into new works (mash-ups or overlays), remixes, and/or moral rights restrictions (e.g., restrictions on use of the content as political messages). In addition, content metadata database 214 can include details regarding whether or not a work is derived from another source, for example, a derivative works registry, to track the paternity chain of derived works. Alternatively, part or all of the ownership information may be stored in accounting system 212 (e.g., in accounting database 224) for operational efficiency considerations.

Content management system 208 can further include content maintenance tool 218 for importing digital content files and associated metadata from various sources. The actual digital files may be transmitted by any suitable means including, for example, file uploading or manual importing from a physical medium. Metadata may also be acquired by any suitable means such as an Extensible Markup Language (XML) dump from an external database and/or manual entry. Using content maintenance tool 218, digital content files can be stored in content file storage 216, and content metadata can be stored in content metadata database 214. Content maintenance tool 218 may also be used to collect and store content ownership metadata in accounting database 224, provide bulk-import capabilities to allow the importing of large volumes of content, and/or generate digital content files from a provided digital content file in alternative formats, which may also be stored in content file storage 216.

Furthermore, content maintenance tool 218 can generate one or more digital fingerprints of the digital content using fingerprinting kit 260. When content files are added to content file storage 216, fingerprinting kit 260 can be used to generate fingerprints for the content files. The generated fingerprints can be added to content metadata database 214 through content maintenance tool 218.

Content distribution system 202 may be located at various service providers (e.g., service provider 120) and/or local (and/or global) operators (e.g., operator 284). Content distribution system 202 can include, for example, network 228, content server 230, and/or content publishing tool 232. Content distribution system 202 can be designed to allow the distribution of large amounts of digital content (e.g., music, movies, documents, or executables) to a large number of clients on multiple platforms. For example, network 228, which may be a P2P network, may utilize one or more levels of super-peer servers as described above to provide adequate quality of service (QoS) for content distribution. To protect user privacy, network 228 may use a P2P protocol such as Freenet which provides enhanced user anonymity. Such a protocol can make it difficult for administrators or other users to determine which content has been requested by any given user. Content server 230 may be a P2P seeding server and may act as an initial seeder of content files. Although server 230 and network 228 are shown as separate entities in FIG. 2, server 230 may be considered a part of network 228.

Content publishing tool 232 can be used for releasing content files for consumption by end users. Content publishing tool 232 allows administrators to determine which content from content management system 208 is to be released for distribution to customers of various service providers. Content publishing tool 232 can combine content metadata from the content metadata database 214 with digital content files from content file storage 216, and can release those files to content server 230.

Content server 230 can be maintained by local (and/or global) operator 284 and/or service provider 120. Server 230 can take account of content metadata for any given content file before serving it to network 228. Using this functionality, availability of certain content may be restricted to only certain service providers based on subscription agreements. For example, a service provider serving a university community may choose to only subscribe to education related content, and a content server may take this into account and only distribute education related content to network(s) operated by the service provider. In some embodiments, server 230 and/or network 228 can collect content usage data (e.g., number of times a content is downloaded) and communicate the collected content usage data back to usage tracking system 206. In this case, the content usage data can be tagged with metadata uniquely identifying the content.

Network 228 (which may include content server 230) may utilize known P2P protocols such as BitTorrent. In some embodiments, network 228 can utilize a “block prioritization” method to efficiently enable streaming playback of large content files such as videos. Unlike BitTorrent, by which a P2P client can download blocks of a large file from various peer nodes in a random order, network 228 can use a protocol that enables a P2P client to prioritize the blocks and to download high priority blocks first. Using such a “block prioritization” method, a P2P client does not have to download the whole file before playing the file. Instead, the P2P client may download a portion of the file (e.g., a video), start playing the video, and at the same time determine which other blocks of the file will be needed soon for playing and download these blocks in a prioritized manner. Such a “block prioritization” method is particularly suitable for streaming video applications.

Usage tracking system 206 can be used to gather data on the usage of content by individual users (e.g., user 106). Content usage data can be used for determining the amount of royalty payments to be distributed to content owners. Usage tracking system 206 can be used to assess the relative usage among various content files as well as absolute usage of any given content file. Usage tracking system 206 can receive and process content usage data collected by content distribution system 202 as described above. In addition, usage tracking system 206 can collect content usage data using software installed at user devices (e.g., networked computers, personal digital assistants, cell phones, etc.).

Usage tracking system 206 can include usage tracking service 244, usage tracking plug-in 246, and/or usage tracking built-in 248 located at a device used by user 106. For each device used by user 106, one or more of usage tracking service 244, usage tracking plug-in 246, or usage tracking built-in 248 may be used to track content usage on that device. Usage tracking system 206 can also include usage marshalling server 250, usage collector 252, usage database 254, and/or usage reporting tool 256, which may be located at service provider 120 and/or operator 284.

By using client side tracking via a user-side device that includes usage tracking service 244, usage tracking plug-in 246, and/or usage tracking built-in 248, usage tracking system 206 need not depend upon network 228 or any other content distribution network to collect usage data. For example, usage tracking system 206 can track usage of content that is acquired by means other than using a distribution network (e.g., content that is acquired from a physical medium or email). Content usage data that can be acquired may include number of content file accesses (opening, playing, etc.), duration of content file accesses, time when the content file is opened, which segment(s) of the content file is played or otherwise used, what application opened the content file, copying of the content file to external media (e.g., CD or DVD), copying of the content file to removable memory devices (e.g., iPods, memory devices using Universal Serial Bus (USB) drives), and/or other information about uses.

In some embodiments, usage tracking system 206 can combine usage data obtained from both a content distribution network (e.g., network 228) and from client-side tracking to achieve higher accuracy. For example, data collected by a distribution network (e.g., network 228) can be particularly useful for establishing a usage baseline for very low-utilization content, because every single download of a content file can be recorded by the distribution network (e.g., network 228). In addition, data collected by a distribution network (e.g., network 228) can be used for establishing usage norms of contents. By comparing these data with data collected by usage tracking system 206, attempts to “cheat” usage tracking system 206 (e.g., an owner of a content artificially inflating usage counts of the content) can be detected.

Usage tracking service 244 can be a program installed on a large number of user devices. Usage tracking service 244 can run as an unobtrusive background process that can monitor file-system access, audio output buffer, video output (screen) buffer, and/or some combination thereof. Usage tracking service 244 can be implemented, for example, as a kernel extension on any suitable operating system such as Windows, Mac OS, Unix and/or Linux. On Windows-based systems, usage tracking service 244 may incorporate a file system filter driver or mini filter for file access. On the Apple OS X platform, usage tracking service 244 may employ the Kernel Authentication subsystem, or kauth. On the Linux platform, usage tracking service 244 may employ the inotify event-monitoring system.

In some embodiments, when usage tracking service 244 determines that the system has accessed a content file for playback, it can check a cached lookup table to determine if the content file has been fingerprinted before. If there has not been a fingerprint made previously, service 244 uses fingerprinting kit 260 to generate one or more fingerprints of the content file. If a fingerprint is already cached, usage tracking service 244 uses the cached fingerprint to reduce processor load. In some embodiments, fingerprinting may be performed by usage tracking service 244 when a media content file is being played. Alternatively, fingerprinting tasks may be queued and performed during periods of low processor load.

In one embodiment, usage tracking service 244 can check with a file identification database, such as the fingerprint database in content metadata database 214, to see if the content file is registered with content management system 208. If the content file is not registered with system 208, usage tracking service 244 can disable usage tracking and/or reporting with respect to the particular content file, so that content usage is reported only for content files that have been previously registered with system 208. Usage tracking service 244 may also disallow the unregistered content file from being transferred by an associated file transfer application to another device or over a network. Alternatively, usage tracking service 244 reports content usage for all content files without checking whether the content files have been registered or not.

Usage tracking service 244 can collect information regarding content usage. For example, service 244 can record the length of time that a content file was played (or otherwise used) by user 106 and the portion(s) of the content file that was played (or otherwise used). Service 244 can also record events such as copying of the content file to external media (e.g., CD or DVD) and/or to removable devices (e.g., iPods, memory devices using Universal Serial Bus (USB) drives). If a known removable device that contains content files is disconnected and then reconnected to the user device, service 244 may extract content usage information from the removable device, if available.

Usage tracking service 244 can then send the generated fingerprint(s) and content usage information upstream to usage marshalling server 250 and/or usage collector 252. In some embodiments, usage tracking service 244 can periodically compile a list of content file accesses and related information, and send the list upstream for processing when the user device is online. Using the generated fingerprints, usage collector 252 can identify various contents by searching for the fingerprints in content metadata database 214.

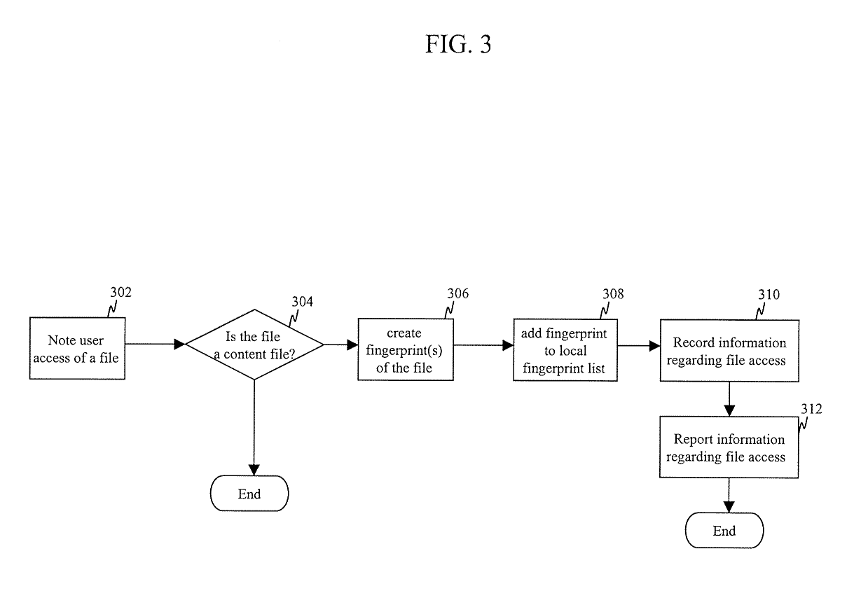

FIG. 3 is a flow chart illustrating the operation of usage tracking service 244 when a content file is accessed. At 302, when a user starts to play, copy, or otherwise access a file using a device (e.g., networked computer, personal digital assistant, cell phone, etc.), it can be noted and recorded by usage tracking service 244 located on that device. At decision step 304, usage tracking service 244 can determine whether the file is a content file. This determination can be made by checking the file extension names and/or by any other suitable techniques. If it is determined that that the file is a content file, service 244 can create a fingerprint of the file for identification purposes at 306. At 308, service 244 can add the fingerprint to a local fingerprint cache or list. At 310, service 244 can record the duration of file access, the portions of content file that is accessed, and/or other information relating to file access. This recording may be performed, for example, when file access is over. At 312, information relating to file access that is recorded at 310 may be reported, for example, to usage marshalling server 250 and/or usage collector 252 shown in FIG. 2. This may occur periodically if the device is online and can be pushed by the user or pulled by the server by polling users.

Referring again to FIG. 2, usage tracking plug-in 246 and usage tracking built-in 248 can serve similar functions as usage tracking service 244. Usage tracking plug-in 246 can be an application based software component that can be integrated with media playback software on major platforms. Usage tracking built-in 248 can be a firmware based software component for third-party integration with standalone devices such as network connected mobile phones and media players. Usage tracking plug-in 246 and usage tracking built-in 248 can utilize fingerprinting kit 260 that is optimized for the particular platform on which they operate, and may interact with an already-installed usage tracking service 244 to increase accuracy and efficiency.

Usage marshalling server 250 can be used to collect and pre-process content usage data at the service provider level before delivering usage reports upstream to usage collector 252. Alternatively, content usage data may be sent to usage collector 252 directly. Usage collector 252 may be maintained by operator 284 and can collect usage data from multiple sources, including, for example, content server 230, network 228, usage marshalling server 250, and end-user usage tracking service 244. Usage collector 252 may also collect usage data from other seeding servers, distribution networks, marshalling servers, and end-user devices not shown in FIG. 2. Usage marshalling server 250 can decrypt any encrypted incoming data and perform any suitable consistency and validity checks before storing the data in usage database 254.

Usage reporting tool 256 can provide detailed reports and summaries on content usage. These reports may be used for any number of purposes including fraud prevention, marketing, and/or accounting. However, content usage reports can include private information regarding the user that needs to be protected.

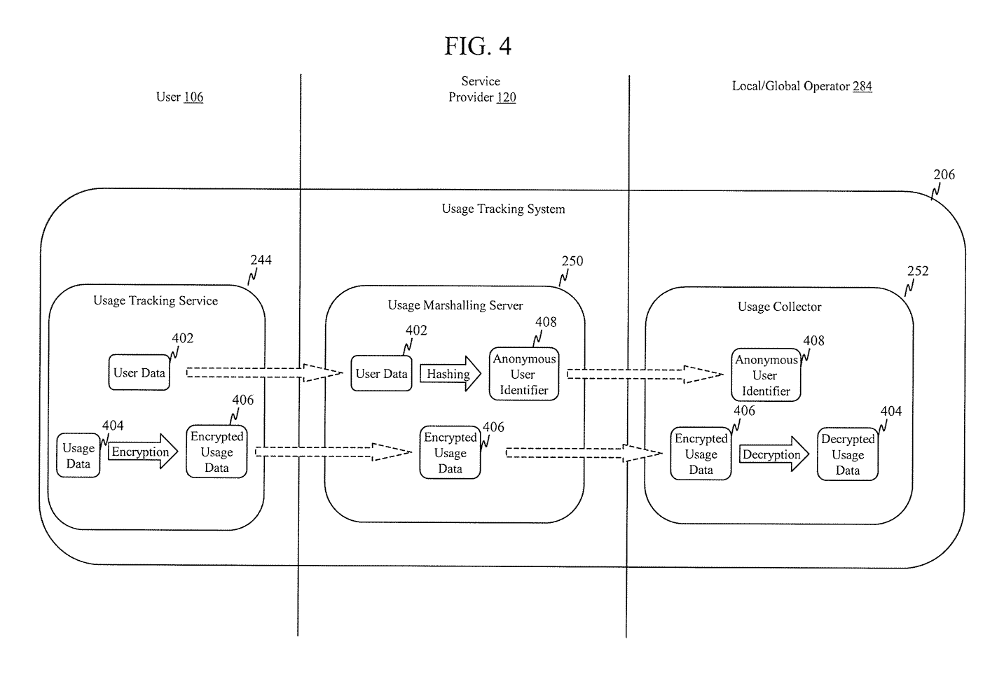

FIG. 4 is a flow diagram illustrating components of usage tracking system 206 processing and communicating information in a manner that protects user privacy, according to various embodiments of the present invention. As shown, usage tracking service 244 that is located on a device used by user 106 can have user data 402 and content usage data 404. User data 402 may include Internet Protocol (IP) addresses, Media Access Control (MAC) addresses, and/or other information that allows the identification of a specific user. Usage data 404 may include filenames, fingerprints, and/or other information that allows the identification of particular content files that is used. Usage tracking service 244 may send user data 402 to usage marshalling server 250 that may be located at service provider 120. Usage tracking service 244 may also encrypt usage data 404 and send encrypted usage data 406 to usage marshalling server 250. To encrypt usage data 404, any suitable encryption method may be used, including, for example, public key cryptography, in which case usage data 404 may be encrypted using a public key (not shown).

Usage marshalling server 250 may send the received encrypted usage data 406 to usage collector 252 that may be located at local (and/or global) operator 284. Usage collector 252 can decrypt encrypted usage data 406 using, for example, a private key. Using received user data 402, usage marshalling server 250 can also create unique pseudonymous user identifier 408 representing user 106. This may be achieved by applying a hashing algorithm (e.g., a one-way hashing algorithm such as SHA-512) to user data 402 in a known manner. Pseudonymous user identifier 408 can also be sent to usage collector 252. User identifier 408 can then be used by usage collector 252 to represent a unique user without maintaining any information on the identity of that user. In some embodiments, pseudonymous user identifier 408 can be created by usage tracking service 244, in which case pseudonymous user identifier 408 and encrypted usage data 406 can be sent to usage collector 252 directly.

Because usage marshalling server 250 can receive encrypted usage data 406 (and not unencrypted usage data 404), a person who has access to usage marshalling server 250 will not be able to obtain content usage information relating to a particular user. In addition, because usage collector 252 does not have user data 402, but only pseudonymous user identifier 408, a person who has access to usage collector 252 will not be able to associate a certain piece of content usage data 404 with any particular user. Therefore, user privacy is protected. At the same time, usage tracking system 206 can determine that multiple usage reports within a specific time period originate from the same user without knowing the identity of the user. That is, system 206 can retain user uniqueness while obscuring user identity.

Referring again to FIG. 2, accounting system 212 can include accounting database 224, accounting business logic 220, and/or accounting management tool 222. As described above, accounting database 224 can include content ownership information such as a derivative works registry. Accounting database 224 can also include predefined royalty rules for calculating royalty payments. The rules can be based on criteria such as total downloads, total individual access of a file, newness of a piece of content, and/or individual users' customized personal content catalogs.

Accounting business logic 220 can include royalty calculation and distribution process. This can be an automatic process that is periodically run (e.g., on a monthly basis) that takes information from content owners application logic 234 (described below), accounting database 224, and/or usage database 254. Based on these information and predefined royalty rules (e.g., royalty rules stored in accounting database 224), business logic 220 can determine royalty payouts for each piece of content. Once royalty payouts are determined, they can be saved to accounting database 224. Payouts can be made using the content owner's preferred method (e.g., check, Electronic Data Interchange (EDI), PayPal), after which royalty payout reports can be generated. Content owners can review royalty payout reports using content owners application 210.

According to various embodiments, system 200 may provide a group of users a large pool of content and require each user, or the group of users, to pay a flat subscription fee (e.g., a flat monthly fee) regardless of content usage by each individual user. In this case, accounting business logic 220 can calculate royalty payments according to relative usage of different contents in the content pool (i.e., usage of a single content relative to total usage of contents in the content pool). In other words, the total amount of subscription fee collected from the group of users is distributed to content owners according to relative usage of the contents instead of absolute usage. In this case, therefore, usage tracking system 206 need not provide accounting system 212 with a completely accurate account of content usage; a certain level of accuracy regarding relative usage can enable accounting system 212 to calculate royalty payments fairly.

In some embodiments, accounting business logic 220 can calculate royalty payments by distributing each individual user's subscription payment to content owners according to the particular user's content usage. Using the anonymous but unique user identifier 408 described in connection with FIG. 4, usage tracking system 206 can keep track of each individual user's content usage as a separate pool, and distribute payments to content owners based on each individual user's payment. For example, if user A consumes 10 content files in a time period and if user B consumes 100 content files in the same time period, and if both users pay the same subscription fee, the value of user A's consumption per use is 1/10 of user B, and owners of contents consumed by user B will receive in total the same amount as owners of contents consumed by user A. Therefore, if a content owner downloads or plays owned material over and over again, he or she would not be able to artificially inflate his or her royalty payments. This method of keeping track of and compensating for usage prevents “spoofing” of the system by adding false content usage information to the database, because each user's account will always pay out the amount collected minus an administration fee. Adding a large number of bogus plays to such system has little effect on the distribution and would trigger available policing applications.

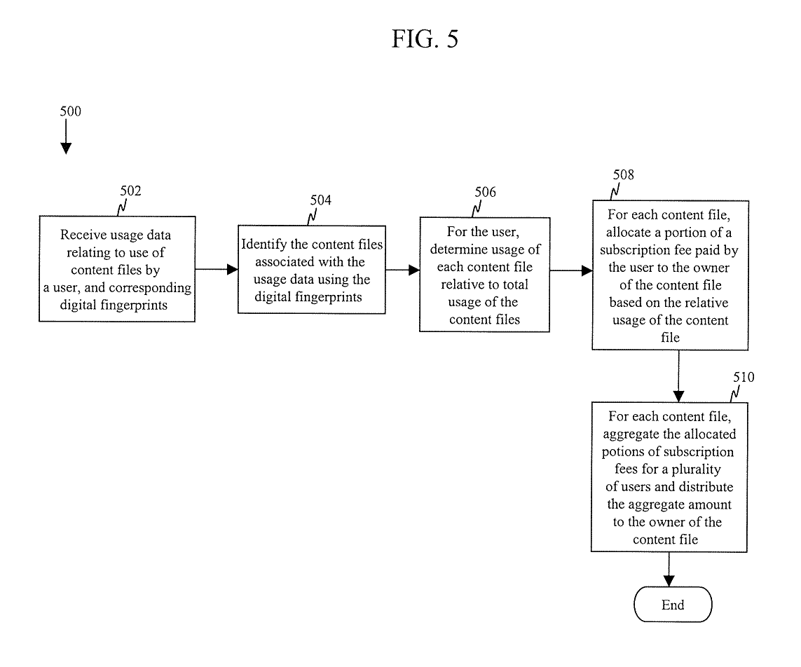

FIG. 5 illustrates such a method that can be used by system 200 for calculating royalty payments. At step 502, usage collector 252 shown in FIG. 2 receives usage data relating to a users' usage of content files along with digital fingerprints. At step 504, each of the content files can be identified with a received digital fingerprint and associated with corresponding usage data. At step 506, accounting system 212 can determine, for the user, usage of each content file relative to total usage of the content files by the user. This relative usage may include, for example, time that a content file is played (or otherwise accessed) relative to total time that the user spent on the content files during a certain time period. This relative usage may also be calculated in any other suitable manner using one or more different types of usage information. For example, the relative usage may be based on the number of times that the content file is accessed (and/or copied) relative to the total number of times that the content files are accessed (and/or copied) by the user. At step 508, for each content file, accounting system 212 can allocate a portion of a subscription fee paid by the user to the owner of the content file, based on the relative usage determined in step 506. At step 510, accounting system 212 can aggregate the allocated portions for a group of users and distribute the aggregate payment to the owner of the content file.

It is possible that users of system 200 could try to artificially inflate royalty payments by secretly controlling other devices remotely (e.g., by use of a malicious agent) and use these other devices to download or play certain content. Various technologies or strategies may be employed to thwart these attempts. For example, usage tracking system 206 can filter usage reports so that they are only allowed from machines that show network addresses on licensed networks.

Usage tracking system 206 and/or accounting system 212 may also perform statistical analysis of aggregate usage, making sure, for example, that the distribution of various metadata for each content item follows normal patterns. In some embodiments, usage tracking system 206 and/or accounting system 212 may statistically analyze groups of usage data, each group corresponding to, for example, a region or a service provider from which the usage data is collected, and determine usage of a content item relative to total usage for each group. This relative usage of the content item can then be compared across the different groups to detect any anomalies. For example, if the relative usage of the content item for the different groups does not follow a normal distribution, it may indicate that bogus usage information may be reported in some groups. Usage tracking system 206 and/or accounting system 212 may also obtain and analyze content download information from, for example, network 228, and compare that with usage information obtained by client-side usage tracking system 206. For example, if the number of downloads for a content item relative to total downloads as reported by network 228 substantially differs from relative usage of the content as reported by usage tracking system 206 for the same network, it is likely that false usage information is reported.

User 106 served by service provider 120 can access network 228 using content catalog application 204 and/or any other suitable means. Content catalog application 204 can include a web-based application accessible through standard Web browser 242, customized catalog front-end 238 specific to a given class of client, application catalog access plug-in 240 to an existing media management application, and/or any other suitable means. Content catalog application 204 can also include catalog application logic 262 and catalog database 266. Catalog application logic 262 can interface with content metadata database 214 and catalog database 266. Catalog database 266 can be used, for example, to store customized content catalogs for different users and/or organizations. System 200 can allow multiple and different types of applications to access content catalogs stored in catalog database 242.

Content catalog application 204 can collect and display information on available content, allowing users to browse through content and select items for preview and/or download. Using customized content catalogs stored in catalog database 266 and content metadata stored in content metadata database 214, catalog application logic 262 can generate customized portal Web pages displaying available content to a particular user or organization. In some embodiments, it can provide usable peer-to-peer links (using BitTorrent or a similar protocol) to allow users to download content from network 228 provided by service provider 120. Content catalog application 204 can also be used to access recommendation engines, save content locally, create and link to playlists, create and join groups, collaborate on creating contents, and/or social networking.

Content owners application 210 can be a web-based application to allow content owners to interface with system 200. It can be used to import content, enable content metadata management including territory permissions and ownership information, report content usage to content owners, and/or provide accounting reports and account management.

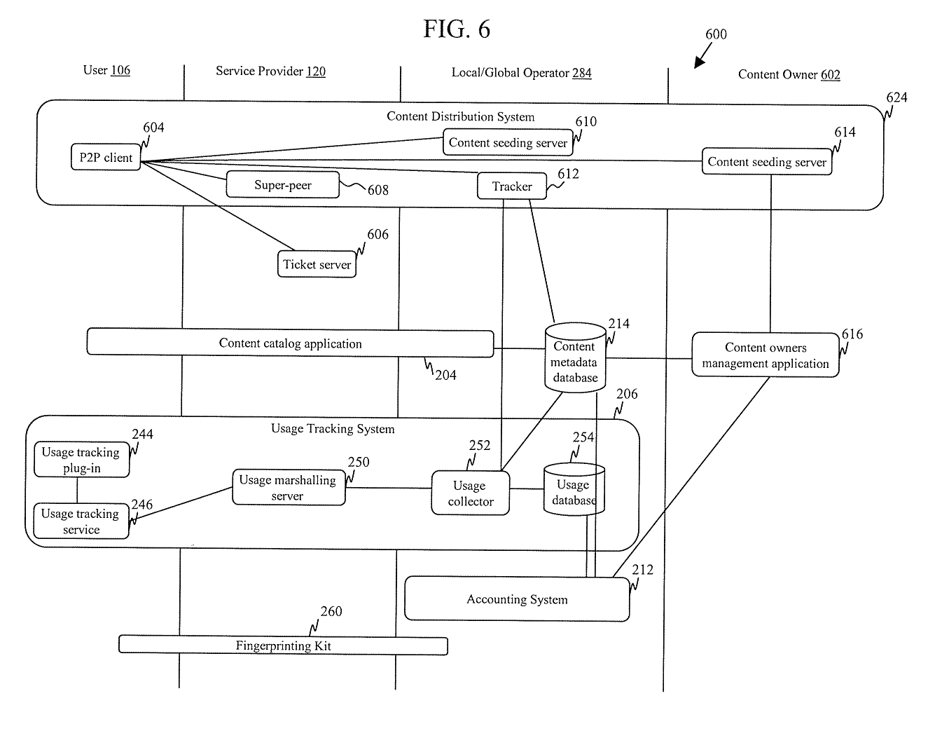

FIG. 6 illustrates another content distribution and usage tracking system 600 according to various embodiments. System 600 can include various subsystems such as ticket server 606, content distribution system 624, content catalog application 204, content metadata database 214, content owners management application 616, usage tracking system 206, accounting system 212, and/or fingerprinting kit 260. Some of these subsystems (or components in these subsystems), such as content catalog application 204, usage tracking system 206, content metadata database 214, accounting system 212, and/or fingerprinting kit 260 have been described in connection with system 200 shown in FIG. 2. In addition to features of system 200 described in connection with FIG. 2, system 600 can include any number of content seeding servers (e.g., servers 610, 614) operated by any number of local/global operators and/or content owners for delivering content to P2P networks, and can include an authentication mechanism for authorizing user requests by use of tickets, as described below.

Components of system 600, such as content distribution system 624, can be distributed across multiple locations including user 106, service provider 120, local (and/or global) operator 284, and content owner 602. In addition, different components of system 600 that reside at a particular location may be installed and/or combined in a single computer or device. For example, content seeding server 614 of content distribution system 624 and content owners management application 616 may be installed in a single server computer located or provided by content owner 602.

Ticket server 606 may be located at service provider 120. To authenticate user 106, ticket server 606 can receive authentication information from P2P client 604, which may include an IP address, username/password of user 106, and/or other authentication information. Using this information, ticket server 606 may interface with service provider 120's billing and/or membership database(s) (not shown) to verify user 106's identity and validity. After ticket server 606 authenticates user 106, ticket server 606 can generate and send user 106 a ticket for download transactions. In one embodiment, ticket server 606 signs the ticket, using, for example, a private key. The signed ticket can be verified at tracker 612 and/or content seeding servers 610, 614 (which are described below) using an associated public key. In an alternative embodiment, ticket server 606 can be located at local (and/or global) operator 284, or operated by a territorial government, and may maintain user subscription accounts directly for authenticating the users.

A ticket generated by ticket server 606 can include various information such as the IP address of P2P client 604, the territory in which the requesting client resides, an identifier for service provider 120, the hashed identifier of a requested file, and/or the time at which the request was made. At tracker 612 and/or content seeding servers 610, 614, a ticket can be determined as invalid if it cannot be verified, or the payload information is unreadable, in which case tracker 612 and/or content seeding servers 610, 614 can refuse the user request. Even if a ticket is valid, tracker 612 and/or content seeding servers 610, 614 may still refuse a user request, for example, on the basis that the requested file is not licensed for distribution within the given territory or service provider. Tracker 612 and/or content seeding servers 610, 614 may also refuse a request when an IP address in the ticket does not match the IP address of the requesting client, or when a predetermined period of time has elapsed since the ticket was generated. These measures can prevent unauthorized sharing of accounts by users.

Ticket server 606 can also provide various “gaming” countermeasures. For example, server 606 can limit the number of tickets granted to a given user in a given time period, and/or limit the number of different IP addresses from which a user may request tickets in a given time period. Ticket server 606 may also refuse to grant tickets to a user that is requesting outside of a service provider network or territory associated with the user. Server 606 can record gaming attempts for prosecution purposes.

Content distribution system 624 can be used to distribute content across a P2P network. As shown, system 624 can include P2P client 604 used by user 106, super-peer 608, tracker 612, and content seeding servers 610 and 614.

P2P client 604 can be implemented, for example, as a plug-in application to another application such as a Web Browser. P2P client 604 can communicate with ticket server 606 to obtain a ticket for accessing content. Using the obtained ticket, P2P client 604 can also communicate with tracker 612 for a list of peers, super-peers (e.g., super-peer 608), and/or seeding servers (e.g., content seeding servers 610, 614) that are serving a desired content file, and communicate with these peers, super-peers, and/or seeding servers to request specific blocks of the content file. Simultaneously, P2P client 604 may upload blocks of the content file to other peers in the P2P network.

Tracker 612 can be located at local (and/or global) operator 284. In some embodiments, tracker 612 can maintain information on downloading sessions in P2P networks and can be used to coordinate the behavior of peers. Tracker 612 can, for example, provide user 106 with a list of peers, super-peers (e.g., super-peer 608), and/or seeding servers (e.g., content seeding servers 610, 614) that are serving a desired content file upon receiving a valid ticket from user 106. In some embodiments, tracker 612 can include functions of a typical BitTorrent tracker. Alternatively, tracker 612 can be based on other P2P network protocols.

In some embodiments, tracker 612 can report download activities of content files to usage collector 252. For example, tracker 612 may track and report all download requests made by users, so that usage of infrequently-used content can be measured accurately, especially in situations where client-side tracking by usage tracking system 206 only samples content usage for a group of users. Content download information recorded by tracker 612 can also be compared with information obtained from client-side tracking to detect gaming. For example, because the ratio of download activities to actual client-side usage of a content file likely follows a normal distribution, a ratio that falls outside the normal distribution may suggest that the reported client-side usage of the content file overstates actual usage, and therefore lead to further investigation. Tracker 612 may also communicate with content metadata database 214 to send or receive various information, such as locations of seeding servers for any given content file, and/or information regarding which content files have been released to the network.

Super-peer 608 can be located at service provider 120 and appear as a peer in a P2P network. Super-peer 608 can communicate with tracker 612 so as to function as a cache for frequently requested content files. User 106 can download some or all blocks of a desired content file from super-peer 608 upon presenting a valid ticket to super-peer 608. In some embodiments, user 106 can download blocks of a desired content file from super-peer 608 and download other blocks of the content file from one or more other peers in a P2P network.

In content distribution system 624, one or more content seeding servers (e.g., server 610, 614) may be operated by one or more operators (e.g., local (and/or global) operator 284) and/or content owners (e.g., content owner 602). In either case, the content seeding servers (e.g., server 610, 614) can seed content files onto P2P networks, allowing registered content files to always be available. Content seeding servers 610, 614 may interact with content owners management application 616 for obtaining copies of content files.

As described in connection with FIG. 4, usage tracking system 206 in systems 200, 600 can utilize usage marshalling server 250 to protect user privacy. Alternatively, in system 600, usage tracking service 246 can request a unique pseudonymous “ID ticket” from ticket server 606. The ID ticket can be signed with ticket server 606's private key, guaranteeing that it corresponds to a valid user, and sent along with encrypted usage data to usage marshalling server 250 and/or usage collector 252. The ID ticket does not include personal information that can be used to identify a user. However, the ID ticket can be used by usage collector 252 to represent a unique user. In addition, non-personal data such as demographic information can be embedded within the ID ticket. Using this approach, because each usage message (or report) sent by a user requires authorization by ticket server 606, certain gaming attempts are thwarted.

The description has referred to systems, subsystems, databases, processors, and servers. These terms should be understood broadly to cover a wide range of hardware and/or software that can be used to implement these components. In addition, what is described as separate servers could be located together in one location (co-located) or could even share processing hardware but use different software. The various subsystems could be implemented substantially all in hardware or software, but would typically be implemented primarily with software executed on a processor, that could also implement other software that implements other systems. The processors and servers can be general purpose devices for implementing any appropriate software, or could be application-specific processors or controllers for devices, such as appliances.

In the description above, there are references to databases, but any form of memory that is suitable to hold the data could be used. There are references to multiple databases, but multiple databases or storage media can be co-located, or could be multiple tables within the same physical database. References to multiple databases could refer to physically separate databases stored at remote locations.

Other embodiments, extensions, and modifications of the ideas presented above are comprehended and within the reach of one skilled in the field upon reviewing the present disclosure. Accordingly, the scope of the present invention in its various aspects is not to be limited by the examples and embodiments presented above. The individual aspects of the present invention, and the entirety of the invention are to be regarded so as to allow for modifications and future developments within the scope of the present disclosure. The present invention is limited only by the claims that follow.

1. A method for tracking content usage, comprising:
determining that a content file is accessed by a user using a network device;
recording, at the network device, usage data relating to the user's access of the content file;
encrypting the usage data at the network device;
creating a digital fingerprint of at least a portion of the content file at the network device; and
reporting the encrypted usage data and the created digital fingerprint to a server.

2. The method of claim 1, further comprising sending to the server user identification information that identifies the user.

3. The method of claim 2, wherein the sending comprises:
obtaining user data that identifies the user;
applying a hashing algorithm on the user data to create a unique user identifier representing the user; and
sending the unique user identifier to the server.

4. The method of claim 1, wherein the encrypting comprises encrypting the usage data using a public key.

5. The method of claim 1, further comprising obtaining a ticket that authenticates the user.

6. The method of claim 5, wherein the ticket is signed with a private key.

7. The method of claim 5, further comprising using the ticket for retrieving the content file.

8. The method of claim 5, further comprising sending the ticket with the encrypted usage data to the server.

9. A computer program product for tracking content usage, comprising:
at least one computer readable medium, readable by a network device;
instructions, provided on the at least one computer readable medium, for determining that a content file is accessed by a user using the network device;
instructions, provided on the at least one computer readable medium, for recording, at the network device, usage data relating to the user's access of the content file;
instructions, provided on the at least one computer readable medium, for encrypting the usage data at the network device;
instructions, provided on the at least one computer readable medium, for creating a digital fingerprint of at least a portion of the content file at the network device; and
instructions, provided on the at least one computer readable medium, for reporting the encrypted usage data and the created digital fingerprint to a server.

10. The computer program product of claim 9, further comprising instructions, provided on the at least one computer readable medium, for sending to the server user identification information that identifies the user.

11. The computer program product of claim 10, wherein the instructions for sending comprises:
instructions, provided on the at least one computer readable medium, for obtaining user data that identifies the user;
instructions, provided on the at least one computer readable medium, for applying a hashing algorithm on the user data to create a unique user identifier representing the user; and
instructions, provided on the at least one computer readable medium, for sending the unique user identifier to the server.

12. The computer program product of claim 9, wherein the instructions for encrypting comprises instructions, provided on the at least one computer readable medium, for encrypting the usage data using a public key.

13. The computer program product of claim 6, further comprising, instructions, provided on the at least one computer readable medium, for obtaining a ticket that authenticates the user.

14. The computer program product of claim 13, wherein the ticket is signed with a private key.

15. The computer program product of claim 13, further comprising instructions, provided on the at least one computer readable medium, for using the ticket for retrieving the content file.

16. The computer program product of claim 13, further comprising instructions, provided on the at least one computer readable medium, for sending the ticket with the encrypted usage data to the server.

17. A network device, comprising:
means for determining that a content file is accessed by a user using the network device;
means for recording usage data relating to the user's access of the content file;
means for encrypting the usage data;
means for creating a digital fingerprint of at least a portion of the content file; and
means for reporting the encrypted usage data and the created digital fingerprint to a server.

18. A method for a server to track content usage over a network, comprising:
receiving encrypted usage data relating to usage of one or more content files by a user, wherein the usage data is obtained by a network device used by the user to access the one or more content files;
decrypting the encrypted usage data;
receiving one or more digital fingerprints generated from at least a portion of the one or more content files by the network device;
identifying the one or more content files by use of the one or more digital fingerprints; and
determining one or more payments to be distributed to one or more owners of the one or more content files based on the decrypted usage data.

19. The method of claim 18, further comprising receiving a unique user identifier that represents the user, wherein the user cannot be identified from the unique user identifier.

20. The method of claim 18, further comprising:
authenticating the user upon receiving a request from the user; and
sending to the user a ticket upon authenticating the user.

21. The method of claim 20, wherein the ticket is signed using a private key.

22. The method of claim 18, further comprising:
delivering the one or more content files to one or more seeding servers in one or more peer-to-peer (P2P) networks.

23. The method of claim 18, wherein the determining comprises:
determining usage of each of the one or more content files by the user relative to total usage of the one or more content files by the user during a period of time; and
determining one or more payments to one or more owners of the one or more content files by allocating, for each content file, a portion of a subscription fee paid by the user to be distributed to an owner of the content file according to the determined relative usage of the content file.

24. The method of claim 18, further comprising:
receiving a ticket along with the encrypted usage data; and
verifying the ticket to validate the usage data.

25. A computer program product for a sever to track content usage over a network, comprising:
at least one computer readable medium, readable by the server;
instructions, provided on the at least one computer readable medium, for receiving encrypted usage data relating to usage of one or more content files by a user, wherein the usage data is obtained by a network device used by the user to access the one or more content files;
instructions, provided on the at least one computer readable medium, for decrypting the encrypted usage data;
instructions, provided on the at least one computer readable medium, for receiving one or more digital fingerprints generated from at least a portion of the one or more content files by the network device;
instructions, provided on the at least one computer readable medium, for identifying the one or more content files by use of the one or more digital fingerprints; and
instructions, provided on the at least one computer readable medium, for determining one or more payments to be distributed to one or more owners of the one or more content files based on the decrypted usage data.

26. The computer program product of claim 25, further comprising instructions, provided on the at least one computer readable medium, for receiving a unique user identifier that represents the user, wherein the user cannot be identified from the unique user identifier.

27. The computer program product of claim 25, further comprising:
instructions, provided on the at least one computer readable medium, for authenticating the user upon receiving a request from the user; and
instructions, provided on the at least one computer readable medium, for sending to the user a ticket upon authenticating the user.

28. The computer program product of claim 25, further comprising:
instructions, provided on the at least one computer readable medium, for delivering the one or more content files to one or more seeding servers in one or more peer-to-peer (P2P) networks.

29. The computer program product of claim 25, wherein the instructions for determining comprises:
instructions, provided on the at least one computer readable medium, for determining usage of each of the one or more content files by the user relative to total usage of the one or more content files by the user during a period of time; and
instructions, provided on the at least one computer readable medium, for determining one or more payments to one or more owners of the one or more content files by allocating, for each content file, a portion of a subscription fee paid by the user to be distributed to an owner of the content file according to the determined relative usage of the content file.

30. A system for tracking content usage over a network, comprising:
a usage collector component configured to receive and decrypt encrypted usage data relating to usage of one or more content files by a user, wherein the usage data is obtained by a network device used by the user to access the one or more content files, receive one or more digital fingerprints generated from at least a portion of the one or more content files by the network device, and identify the one or more content files by use of the one or more digital fingerprints; and
an accounting system component configured to determine one or more payments to be distributed to one or more owners of the one or more content files based on the received usage data.

31. The system of claim 30, wherein the usage collector component is further configured to receive unique user identifier that represents the user, wherein the user cannot be identified from the unique user identifier.

32. The system of claim 30, further comprising a content distribution system component configured to deliver the one or more content files to one or more seeding servers in one or more peer-to-peer (P2P) networks.

33. The system of claim 30, further comprising a ticket server configured to authenticate the user upon receiving a request from the user, and send the user a ticket upon authenticating the user.

34. The system of claim 33, wherein the ticket server is further configured to sign the ticket using a private key.

35. The system of claim 30, wherein in the determining, the accounting system component is configured to determine usage of each of the one or more content files by the user relative to total usage of the one or more content files by the user during a period of time, and determine one or more payments to one or more owners of the one or more content files by allocating, for each content file, a portion of a subscription fee paid by the user to be distributed to an owner of the content file according to the determined relative usage of the content file.

36. The system of claim 30, wherein the usage collector component is further configured to receive a ticket along with the encrypted usage data, and verify the ticket to validate the usage data.
